(19) United States
(12) Patent Application Publication
(10) Pub. No.: US 2024/0272987 A1
(43) Pub. Date: Aug. 15, 2024

(54) METHODS AND SYSTEMS FOR DETECTING DROPPED DATA WRITES AND CORRUPT DATA

(71) Applicant: International Business Machines Corporation, Armonk, NY (US)

(72) Inventors: Lee Jason Sanders, Chichester (GB); Ben Sasson, North Baddesley (GB); Roderick Guy Charles Moore, Bournemouth (GB); Paul Nicholas Cashman, Alton (GB)

(21) Appl. No.: 18/166,733

(22) Filed: Feb. 9, 2023

(51) Int. Cl. G06F 11/14; G06F 11/10

(52) U.S. Cl. CPC G06F 11/1435; G06F 11/1016

(57) ABSTRACT

A computer-implemented method for detecting data storage errors includes storing first data in a first block corresponding to a first virtual volume, storing second data in a second block corresponding to a second virtual volume, generating parity information for the first data and the second data, and storing the parity information in non-volatile memory at a location corresponding to the logical block address to produce stored parity information. A system and computer program product corresponding to the above method are also disclosed herein.

### BACKGROUND

The subject matter disclosed herein relates generally to data integrity determination.

Currently, systems can understand that some discrepancy or data corruption has occurred. However, these systems often don't understand which of the data elements need to be reconstructed based on the understanding.

### SUMMARY OF THE DISCLOSED EMBODIMENTS

A computer-implemented method for detecting data storage errors includes storing first data in a first block corresponding to a first virtual volume, storing second data in a second block corresponding to a second virtual volume, generating parity information for the first data and the second data, and storing the parity information in non-volatile memory at a location corresponding to the logical block address to produce stored parity information.

A system and computer program product corresponding to the above method are also disclosed herein. The computer program product includes a computer readable storage medium having program instructions embodied therewith, wherein the computer readable storage medium is not a transitory signal per se, the program instructions executable by a processor to cause the processor to conduct the above method. The system includes one or more processors and a computer-readable storage medium similar to the computer readable storage medium that is included in the computer program product.

### BRIEF DESCRIPTION OF THE DRAWINGS

In order that the advantages of the disclosed embodiments will be readily understood, a more particular description of the embodiments briefly described above will be rendered by reference to specific embodiments that are illustrated in the appended drawings. Understanding that these drawings depict only some embodiments and are therefore not to be considered to be limiting of scope, the embodiments will be described and explained with additional specificity and detail through the use of the accompanying drawings, in which:

FIG. 1 is a block diagram illustrating various portions of a computing environment in accordance with at least one embodiment disclosed herein; and

FIG. 2 is a flowchart of one example of a method for creating and storing parity information in accordance with at least one embodiment disclosed herein;

FIG. 3 is a flowchart of one example of a method for identifying data errors using stored parity information in accordance with at least one embodiment disclosed herein;

FIG. 4 is a flowchart of one example of a method for fixing data errors in accordance with at least one embodiment disclosed herein;

FIG. 5 is an architecture diagram illustrating one example of the methods of generating parity information in accordance with at least one embodiment disclosed herein; and

FIG. 6 is a block diagram illustrating one example of a computing stack in accordance with at least one embodiment disclosed herein.

### DETAILED DESCRIPTION OF THE DISCLOSED EMBODIMENTS

One of ordinary skill in the art will appreciate that references throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The technology and solutions disclosed herein reduce the delay incurred by cloud computing clients when provisioning cloud computing clusters and associated resources for use in executing cloud-based applications.

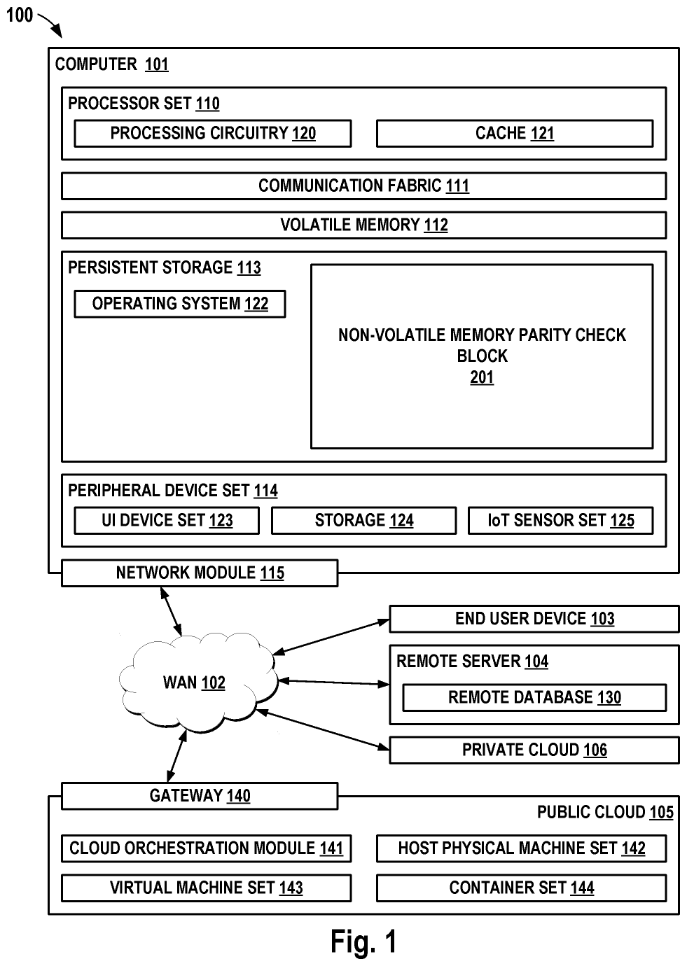

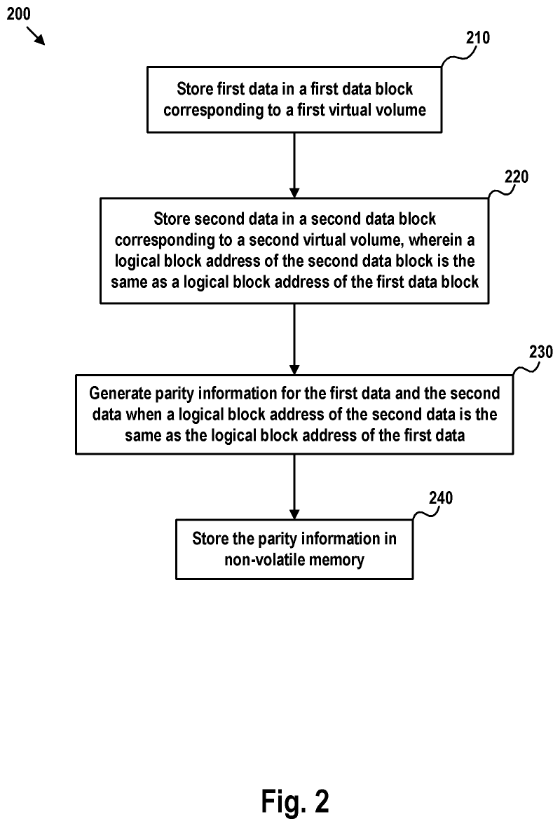

FIG. 1 is a block diagram illustrating various portions of a computing environment 100 in accordance with at least one embodiment disclosed herein. Computing environment 100 contains an example of an environment for the execution of at least some of the computer code involved in performing the inventive methods or processes, such as code block 201 (corresponding to the method 200 shown in FIG. 2). In some embodiments, portions of code block 201 reside within the operating system 122. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented process, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods such as identifying data errors.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 is a flowchart of one example of a method 200 for performing additional parity checks of stored data (e.g., metadata) in accordance with at least one embodiment disclosed herein. As depicted, the method includes storing (210) first data in a first data block, storing (220) second data in a second data block, generating (230) parity information, and storing (240) the parity information. The depicted method allows for data error detection which can lead to applicable solutions.

Storing (210) first data in a first data block corresponding to a first virtual volume having a logical block address may include storing metadata at additional data blocks whereby some or all of the additional data blocks have the same logical block addresses. The metadata stored at data blocks having the same logical block addresses will be used later to generate parity information of, most likely, unrelated metadata/data.

Storing (220) second data in a second data block corresponding to a second virtual volume may include the second data block having a logical block address being the same as a logical block address of the first data block. The second data may be totally unrelated to the first data other than sharing the same logical block address across multiple virtual volumes.

Generating (230) parity information for the first data and the second data when a logical block address of the second data is the same as the logical block address of the first data may include generating the parity information any time data blocks sharing the same logical block address have data written to one of the data blocks. Generating may include updating previously determined parity info. The unit of granularity of the parity may be a pre-determined grain size such as the metadata unit size (e.g., 8k).

Storing (240) the parity information in non-volatile memory may enable a system to easily access the parity information for performing periodic checks or requested checks, such as, without limitation, during data writes of the data blocks sharing the same address.

One of skill in the art will appreciate that the above method for detecting and fixing corrupted data enables improved storage and system operations. Consequently, when a data/system error is detected, data corruption or dropped writes can be detected and corrected.

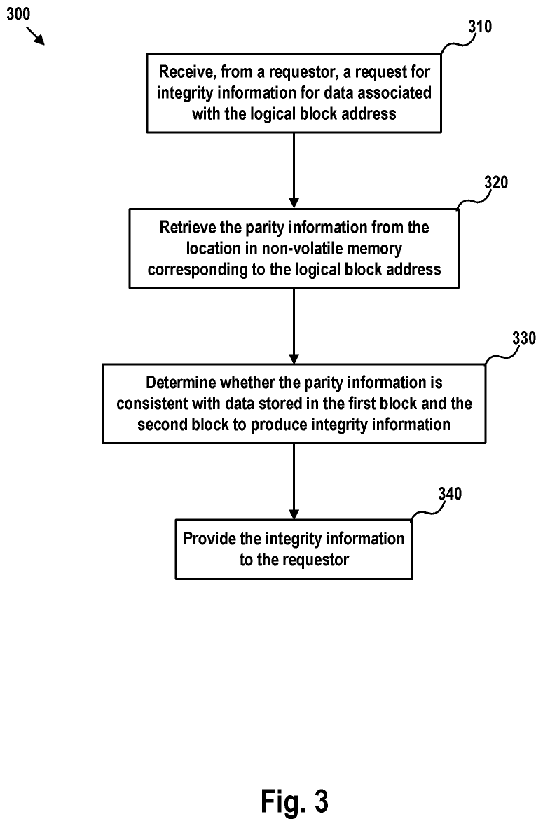

FIG. 3 is a flowchart of one example of a method 300 for preparing data for secure storage and recovery in accordance with at least one embodiment disclosed herein. As depicted, the method 300 includes receiving (310) a request for integrity information, retrieving (320) parity information, determining (330) whether the parity information is consistent, and providing (340) the integrity information to a requestor.

Receiving (310) a request for integrity information. The request for integrity information may be related to data associated with a logical block address may include reading the data from a stored location may include activating the request for integrity information in the case of a primary error indication, such as, without limitation, if the user of the “first data” or “second data” notices a problem with the data. For example, if the first data contains a pointer or reference to another piece of data e.g., “third data” at another logical address and the “third data” does not match the “first data”, then there is a checksum somewhere that mismatches the first data.

Retrieving (320) the parity information may include retrieving the parity information from a location in non-volatile memory. The parity information may be stored according to the logical block address of the associated data and may include accessing the parity information associated with the logical block address associated with block(s) where the data associated with the request is located.

Determining (330) whether the parity information is consistent may include performing a parity check using the parity information and previously stored data in blocks sharing the same logical block address.

Providing (340) the integrity information to the requestor may include indicating to a user that the integrity information is showing negative integrity. In other words, there is a problem associated with some of the data stored at the blocks associated with the similar logical block address related to the parity information.

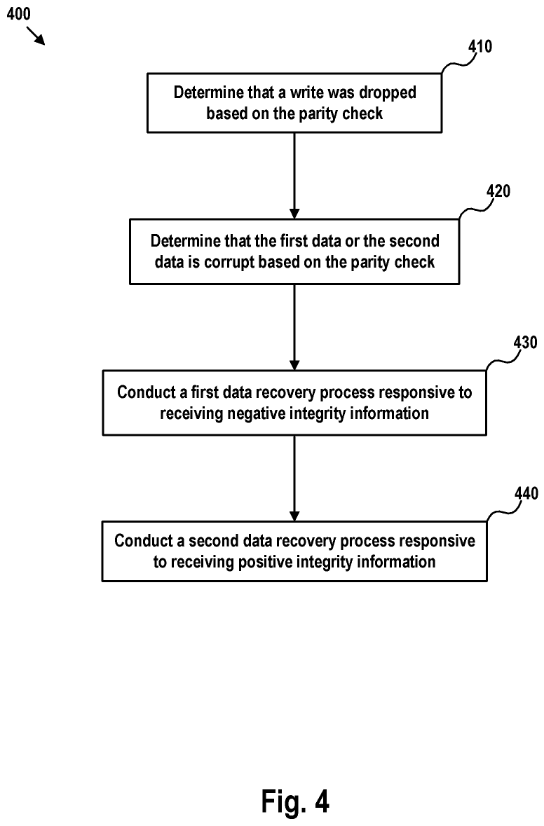

FIG. 4 is a flowchart of one example of a method 400 for identifying specific issues with the stored data. The method 400 may include determining (410) that a write was dropped, determining (420) that the first data or the second data is corrupt, conducting (430) a first data recovery process, conducting (440) a second data recovery process. By determining errors using parity information stored in non-volatile memory, this scheme essentially parity protects the metadata in-memory inside the device, so it is not exposed to failures outside of the device.

Determining (410) that a write was dropped based on the parity check may include using the parity check as an additional check to verify that an initially detected data error is indeed a dropped write error. This may be due to a routine “scrub” process that randomly or serially processes the first and second data to check if there is any corruption. In another example, the user of the first data detects an error, such as the data is inconsistent with another piece of data that it is storing at another logical address. In another example, there could be embedded within the data a reference within the first data to a “third” data.

Determining (420) that the first data or the second data is corrupt based on the parity check may include using the parity check as an additional check to verify that an initially detected data error is indeed a data corruption error.

Conducting (430) a first data recovery process may include performing a data write to the locations associated with the dropped write error, reading the second data at the same logical LBA (as the first—that is corrupt), reading the parity from non-volatile memory, XORing the two together to produce the correct “first” data and writing the first data back to the logical address.

Conducting (440) a second data recovery process may include performing a data correction process for the identified corrupted data such as reading the first data at the same logical address (as the second that is corrupt), reading the parity from the non-volatile memory, XORing the two together to produce the correct “second” data and writing that data to correct the second data.

The methods disclosed herein may be partially or fully embodied within the code block 201 shown in FIG. 1. One of skill in the art will appreciate that the methods disclosed herein may be adapted to the cloud computing environment to which they are deployed without changing the spirit and intent of the disclosed methods. One of skill in the art will also appreciate the utility and effectiveness of the methods and solutions disclosed herein.

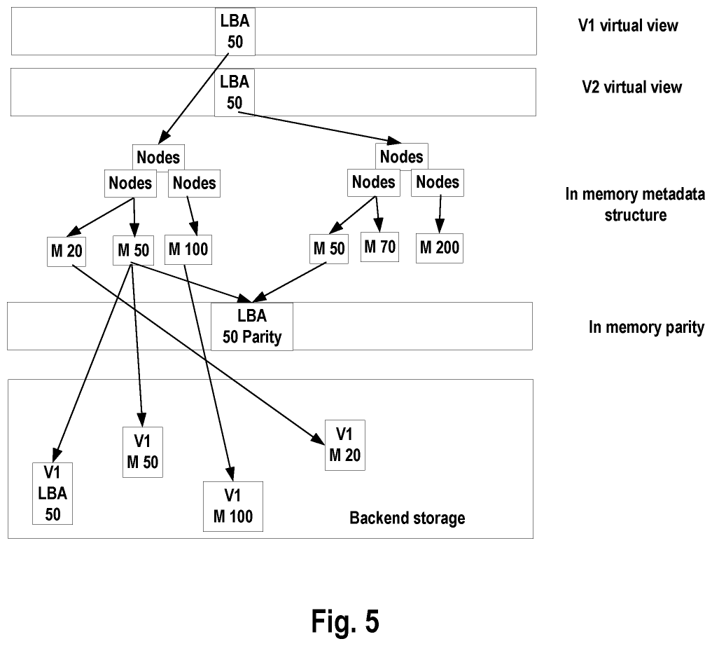

Referring to FIG. 5, data stored at blocks in different virtual views (V1, V2) may have the same address (LBA 50). The metadata stored at these blocks with shared address are used to create parity that is stored in memory parity within non-volatile memory. Essentially, LBA 50 in Virtual View 1 and LBA 50 in Virtual View 2 are pieces of metadata for a “Log Structured Array”. The LSA has a grain size of 8k. The LSA is an industry standard way of organizing logical data on a volume or storage pool. The metadata in LBA 50 at V1 and V2 describes the location of a “User” pieces of data that is being written to the Storage controller from the host server. So LBA 50 at V1 and V2 is internal metadata within the storage system that is also written to the storage controller in addition to the User data that is written by the host server. Metadata LBA 50 on V1 and V2 is organized in a way that can easily be found. The Nodes are a tree structure organizing that data. So, if there were other data written (e.g., LBA 48 V1, LBA 20 V1 etc . . . . LBA 48, 20 and 50) all for V1 would be in the same Tree.

Typically, the metadata for the same volume, V1 would be in the same Tree. And metadata for V2 would be in a different Tree. So, the nodes is describing the Tree that organizes the metadata for that volume (V1 or V2).

The blocks in the backend storage V1 LBA 50, V1 M 50. Basically “V1 LBA 50” is the actual user data written by the host server. “V1 M 50” is the metadata that is in the tree. The metadata is describing the location of the user data written to the storage controller. The parity protection in this invention is only protecting the Metadata “V1 M 50” in this case. So “V1 M 50” is the same piece of data as LBA 50 V1 in the virtual view at the top of the diagram.

The disclosed solutions essentially provide a provisioning framework to more effectively identify correctable data storage problems.

In one embodiment, non-volatile memory is used for detecting and fixing metadata corruption. By applying a parity protection algorithm over the metadata (i.e., data) and storing the parity result in (non-volatile) memory on a storage controller, mismatches can be detected in the metadata. Also, the metadata can be recovered using the stored parity. The stored parity can identify if a write is dropped on the metadata or the data or identify that the data is corrupt.

This parity protection across the metadata effectively acts a quorum device and tie breaks the detection of a mismatch. Whilst also providing recovery for metadata detected corruption. Performing this parity protection is very low cost to any input/output (IO or I/O) as all the data structures involved are stored in memory.

In various embodiments, by employing the non-volatile memory, a scheme is proposed that essentially parity protects the metadata in-memory inside the appliance, so it is not exposed to failures outside of the appliance/device/system or software stack.

The scheme provides a secondary protection mechanism that is independent and expandable which allows the detection of corruption and dropped writes on the backend and, in some cases, allows for fixing of the corruption.

Most metadata structures work in grains, where a grain describes the locations of a range of virtual address locations for a logical volume. The non-volatile memory component is used as a dynamic parity area. Instead of XORing the metadata based on physical layout, metadata grains that reflect the same virtual address of other logical volumes in a domain are XOR'd. The domain could be a storage pool or group of volumes with a shared interest (e.g., flash copy consistency group). A significant advantage of using the virtual address is that the metadata structure is already optimized for this kind of lookup, in addition to that, this allows the bare minimum of the important information to be protected because auxiliary areas on the physical domain, for example, the internal tree structure, do not need to be protected.

This parity area is updated on metadata writes, but because the parity (area/information) is stored in non-volatile memory the parity does not incur I/O amplification which is especially important for metadata as most updates are typically small and random. When the system stages a piece of metadata and follows the metadata to locate the data but finds something that is in doubt, the parity area is used to determine if the metadata is in fact intact or if the data is correct or the metadata is wrong. With knowledge of whether the metadata is intact or corrupt allows the system to employ the correct recovery technique.

Because the parity is in memory and addressable by virtual addresses, the system uses the memory in a dynamic way.

When a domain is first created, any volume that does not exist in the domain is assumed to have metadata of zeroes. This way, when new volumes are added into the domain and written to, the parity is calculated over the new metadata grains and so does not need to read all the pre-existing volumes to update the parity. Furthermore, the system can decide to spend more memory per volume on parity initially. As the system grows more populated, parities are merged together to obtain maximum utilization of the memory.

The parity updates do not add to any IO amplification of staging in the metadata as the metadata will already have been staged to memory to facilitate any ongoing write. All other operations are done in memory and add no overhead.

Because memory prices are rapidly reducing and memory is becoming denser with higher bandwidth, the cost of implementing becomes lower over time with higher reliability.

Using parity this way prevents the whole volume (pool) being taken offline, because the metadata can still be trusted and that the issue becomes a bad-block or medium error as the error was in the data.

During normal operations, both reads and writes, metadata cache gets populated. Every once in a while, all metadata grains for an LBA range across multiple volumes contributing to the same parity at the same virtual address, will be present in cache at the same time, and as such the parity calculation can be applied across all the grains to validate the metadata.

The following may occur in conjunction with the above-described framework and approach.

In various embodiments, the parity may be applied to different quantities of data (byte, block, or the like). The larger the data quantity the faster the performance.

The following are two scenarios where the parity information will be read:

1. In an error scenario where a first data block or a second data block needs to be reconstructed. Reconstruction may occur by reading all the data areas, except for the missing/corrupt data area, and XORing it with the parity.

2. If there is an update the corresponding first data block or second data block—depending on which is being updated, the old data for the first data block or the second data block—respectively must be XOR'd with the new update, to form a parity delta.

The old parity is read and XOR'd with the parity delta to create the new copy of the parity before it is written back.

The parity in non-volatile memory is not written out to storage. It is just used as a sanity check. However, the first data or the second data is written out to storage. If you read the data and the parity XOR the whole grain (first data+second data) and the resulting parity does not match the parity you currently have stored, then a data write did not happen and the backend data is incorrect.

If the parity is correct at the redundant array of independent disks (RAID) layer (which is underneath this layer), this indicates that the write was dropped somewhere between the layer implementation the invention and the RAID layer (e.g., if there was a write cache above the RAID layer).

In various embodiments, one method for detection of the write being dropped is a process called “scrubbing” which is periodic checking that the data in the grain matches the stored non-volatile parity information. In some scrubbing processes the data is systematically walked through at a steady pace to prevent a big scrubbing activity from overwhelming the system.

Since the parity is known, the bad data can be reconstructed by reading all grains (except for the bad data), XORing it with the non-volatile parity in memory, and that will reconstruct the data and then write it back out to the storage.

As disclosed herein, a computer-implemented method for stored data error detection may include: storing first data in a first block corresponding to a first virtual volume; storing second data in a second block corresponding to a second virtual volume, wherein a logical block address of the second block is the same as a logical block address of the first block; generating a parity information for the first data and the second data; storing the parity information in non-volatile memory at a location corresponding to the logical block address; receiving, from a requestor, a request for integrity information for data associated with the logical block address; retrieving the parity information from the location in non-volatile memory corresponding to the logical block address; and/or determining whether the parity information is consistent with data stored in the first block and the second block to produce integrity information; providing the integrity information to the requestor.

Additional features for the above method may include: determining that a write was dropped or that the first data or the second data is corrupt based on the parity check; determining that the first data is corrupt based on the parity check; generating the request for integrity information; wherein generating the request for integrity information occurs in response to a system error; wherein the request for integrity information is generated in response to a periodic request; conducting a first data recovery process responsive to receiving first negative integrity information; wherein the first data recovery process comprises fixing corrupt data; conducting a second data recovery process responsive to receiving second negative integrity information; wherein the second data recovery process comprises fixing a dropped write action; and/or wherein the first virtual volume and the second virtual volume correspond to a backend storage device.

A system and computer program product corresponding to the above method are also disclosed herein. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

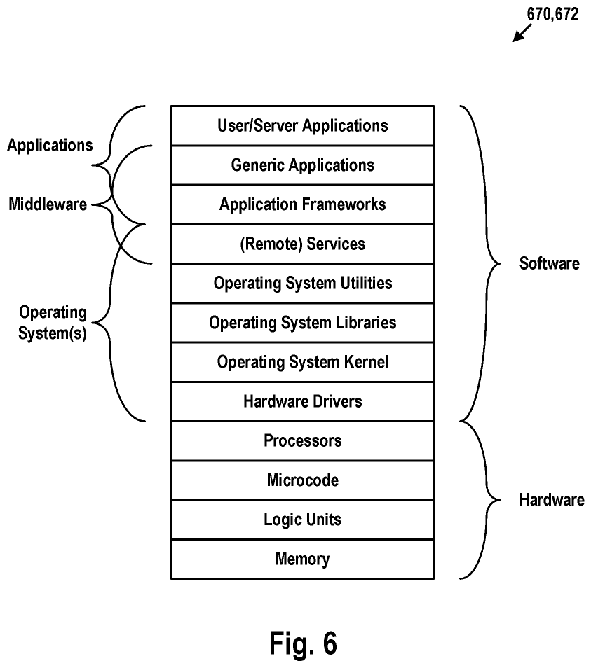

FIG. 6 is a block diagram illustrating one example of a computing stack 670 in accordance with at least one embodiment disclosed herein. As depicted, the computing stack 670 includes a number of computing layers 672 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers, and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 101 and/or the end user devices 103. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

The features, advantages, and characteristics of the embodiments described herein may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Some of the functional units described in this specification may have been labeled as modules, in order to more particularly emphasize their implementation independence. For example, a module may be implemented as a hardware circuit comprising custom vary large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In the preceding description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, processes, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements. The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer-implemented method comprising:
storing first data in a first block corresponding to a first virtual volume;
storing second data in a second block corresponding to a second virtual volume, wherein a logical block address of the second block matches a logical block address of the first block;
generating parity information for the first data and the second data; and
storing the parity information in non-volatile memory at a location corresponding to the logical block address to produce stored parity information,
wherein the first virtual volume and the second virtual volume are pieces of metadata for a log structured array.

2. The method of claim 1, wherein generating the parity information comprises XORing the first data and the second data.

3. The method of claim 2, wherein XORing the first data and the second data is performed at a block level.

4. The method of claim 2, further comprising:
receiving, from a requestor, a request for integrity information for the first data or the second data;
retrieving the stored parity information from the location in non-volatile memory corresponding to the logical block address associated with the first data or the second data;
determining whether the parity information is consistent with the first data in the first block or the second data stored in the second block to produce integrity information to produce integrity information; and
sending, to the requestor, the integrity information.

5. The method of claim 4, wherein providing the integrity information comprises conducting a first data recovery process responsive to the integrity information identifying a first type of negative integrity information.

6. The method of claim 5, wherein the first data recovery process comprises:
identifying a dropped write action; and
performing a scrubbing process responsive to the dropped write action.

7. The method of claim 5, further comprising providing the integrity information comprises conducting a second data recovery process responsive to the integrity information identifying a second type of negative integrity information.

8. The method of claim 7, wherein the second data recovery process comprises:
identifying corrupt data; and
fixing the corrupt data.

9. A computer program product comprising a computer readable storage medium having program instructions embodied therewith, wherein the program instructions are executable by a processor to cause the processor to conduct a method comprising:
storing first data in a first block corresponding to a first virtual volume;
storing second data in a second block corresponding to a second virtual volume, wherein a logical block address of the second block matches a logical block address of the first block;
generating parity information for the first data and the second data; and
storing the parity information in non-volatile memory at a location corresponding to the logical block address to produce stored parity information,
wherein the first virtual volume and the second virtual volume are pieces of metadata for a log structured array.

10. The computer program product of claim 9, wherein generating the parity information comprises XORing the first data and the second data.

11. The computer program product of claim 10, wherein XORing the first data and the second data is performed at a block level.

12. The computer program product of claim 10, wherein the method further comprises:
receiving, from a requestor, a request for integrity information for the first data or the second data;
retrieving the stored parity information from the location in non-volatile memory corresponding to the logical block address associated with the first data or the second data;
determining whether the parity information is consistent with the first data in the first block or the second data stored in the second block to produce integrity information to produce integrity information; and
sending, to the requestor, the integrity information.

13. The computer program product of claim 12, wherein the method further comprises providing the integrity information comprises conducting a first data recovery process responsive to the integrity information identifying a first type of negative integrity information.

14. The computer program product of claim 13, wherein the first data recovery process comprises:
identifying a dropped write action; and
performing a scrubbing process responsive to the dropped write action.

15. The computer program product of claim 13, wherein the method further comprises providing the integrity information comprises conducting a second data recovery process responsive to the integrity information identifying a second type of negative integrity information.

16. The computer program product of claim 15, wherein the second data recovery process comprises:
identifying corrupt data; and
fixing the corrupt data.

17. A system comprising:
one or more processors; and
a computer-readable storage medium having program instructions embodied therewith, wherein the program instructions are executable by the one or more processors to cause the one or more processors to conduct a method comprising:
storing first data in a first block corresponding to a first virtual volume;
storing second data in a second block corresponding to a second virtual volume, wherein a logical block address of the second block matches a logical block address of the first block;
generating parity information for the first data and the second data;
storing the parity information in non-volatile memory at a location corresponding to the logical block address to produce stored parity information;
receiving, from a requestor, a request for integrity information for the first data or the second data;
retrieving the stored parity information from the location in non-volatile memory corresponding to the logical block address associated with the first data or the second data;
determining whether the parity information is consistent with the first data in the first block or the second data stored in the second block to produce integrity information to produce integrity information; and
sending, to the requestor, the integrity information, wherein the first virtual volume and the second virtual volume are pieces of metadata for a log structured array.

18. The system of claim 17, wherein generating the parity information comprises XORing the first data and the second data.

19. The system of claim 17, wherein providing the integrity information comprises:
identifying a dropped write action; and
performing a scrubbing process responsive to the dropped write action.

20. The system of claim 17, wherein providing the integrity information comprises:
identifying corrupt data; and
fixing the corrupt data.
